(19) United States
(12) Patent Application Publication
(10) Pub. No.: US 2016/0317248 A1
(43) Pub. Date: Nov. 3, 2016

(54) DENTAL APPLIANCE REMOVAL TOOL AND METHODS OF USE

(71) Applicant: ZEST IP HOLDINGS, LLC, Escondido, CA (US)

(72) Inventor: Urs Weber, Ramona, CA (US)

(21) Appl. No.: 15/139,162

(22) Filed: Apr. 26, 2016

Related U.S. Application Data
(60) Provisional application No. 62/154,641, filed on Apr. 29, 2015.

(51) Int. Cl. A61C 3/16; A61C 1/00

(52) U.S. Cl. CPC A61C 3/162; A61C 1/0084

(57) ABSTRACT

A dental appliance removal tool is provided with one or more booster tubes each having a pressure-actuated expandable distal portion or cushion which, when inserted between a gum line and an implant-supported denture and connected to a supply of pressured fluid, expands radially to increase the circumference of the cushion and apply pressure to the gum line and denture to loosen or release the denture from an implant or the like. The tool may have an actuation mechanism such as a lever arm which applies pressure to a fluid chamber in communication with the booster tube, causing the cushion to expand, or a manually operated fluid pump or other pressurized fluid supply may be connected to the booster tube or multiple booster tubes to expand the cushion or cushions.

### CROSS-REFERENCE TO RELATED APPLICATIONS

This application claims the benefit of Provisional Application Ser. No. 62/154,641 filed on Apr. 29, 2015, and the contents of the aforementioned application are incorporated herein by reference in their entirety.

### BACKGROUND

1. Field of the Invention

Devices and methods provided herein relate to a dental appliance removal tool or system and method for removing a dental appliance.

2. Related Art

Dental anchoring or attachment assemblies are utilized to anchor a dental appliance with a dental implant or tooth root, typically by fitting two or more partially-movable components together to provide an improved fit and comfort. In some assemblies, male and female parts have mating, snap engageable formations for releasably securing the male part to the female part, with one of the parts secured to an implant or tooth root and the other part pivotally secured to a cap or housing in a dental appliance or prosthesis. For example, the female part has a socket and the male part has a head for snap engagement in the socket.

These dental appliances, such as implant-supported dentures, are often retained by a denture attachment system with a significant amount of force so as to keep the denture affixed to a user's mouth even when the user is chewing or biting on hard, tough foods. The implant-supported dentures are often designed to only be periodically removed by a dental professional for cleaning or replacement of worn parts and will otherwise not need to be removed by the user. Even a traditional adhesive-mounted denture, partial or other dental appliance held in by a friction fit or other means may be difficult to remove due to the fit of the appliance, the buildup of plaque or food, or simply due to the difficulty of accessing the dental appliance.

Due to the significant force required to remove the denture from the implant, a user or dental professional is generally unable to manually remove the denture by hand. Therefore, tools have been devised to perform this function. Many tools require the dental professional to literally snap or pull the denture off the implant in a hard, quick motion which requires a great deal of force. This motion also tends to pull the user's entire head in the same direction, and is at the very least uncomfortable and at the worst painful. Some tools apply a great deal of pressure to the gums, which may cause tissue damage, bleeding or bruising.

It is therefore desirable to remove a dental appliance from an implant without causing discomfort to the user.

### SUMMARY

Embodiments described herein provide for a dental appliance removal tool or system, and for a method of removing a dental appliance using the tool. In one aspect, a dental appliance removal tool comprises at least one booster tube having closed distal end with a pressure-actuated expandable cushion at the distal end portion of the tube, a fluid supply connected to the booster tube, and an actuation device for supplying pressurized fluid from the supply to the expandable cushion, whereby the cushion is expanded to apply pressure between the gum line and dental appliance to release the dental appliance from the gum line. The cushion may have a tapered, thin insertion tip at its distal end to allow for easy insertion in a small gap between a gum line and the denture, as well as additional positioning mechanisms which help in positioning the cushion to expand to release or assist in releasing the denture once actuated.

In one aspect, the proximal end of the tube is formed integrally with or connected to a fluid supply chamber positioned for actuation by an actuation device such as a manually operated lever mechanism which applies pressure to the supply chamber to cause the distal end portion of the tube to expand. In another aspect, the proximal end of the expandable tube is connected via an on-off valve to a source of pressurized fluid or a pump for supplying pressurized fluid to inflate the booster cushion or distal end portion of the tube, similar to a balloon catheter arrangement.

In one aspect, only one booster tube is connected to the supply of pressurized fluid. In another aspect, two, three or more booster tubes are connected to the fluid supply. This allows more than one expandable tube to be used simultaneously to apply lifting pressure at different locations between the gum line and denture, with the tubes connected by a suitable manifold junction to a common supply of pressurized fluid such as purified or deionized water which may be a lever actuated fluid chamber or another source of pressurized fluid such as a pump or the like. The booster tubes may have cushions of different dimensions for fitting gaps of different widths between abutments.

In another aspect, a method of removing a dental appliance is provided, comprising inserting at least one expandable cushion at a distal end portion of a booster tube between a gum line and a dental appliance removably affixed to one or more implants or tooth roots in the gums, and supplying pressurized fluid to the booster tube to expand the expandable cushion and apply pressure to the gum line and the dental appliance to loosen or release the dental appliance.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a perspective view illustration of a dental appliance removal tool according to an embodiment of the invention;

FIG. 2 is an exploded perspective view illustration of the booster tube and actuation mechanism of the dental appliance removal tool of FIG. 1, according to one embodiment of the invention;

FIG. 3 is a top plan view illustrating expandable cushions of different sizes and configurations for selective connection to the actuation mechanism, according to an embodiment of the invention;

FIGS. 4A and 4B are top plan views illustrating the method of positioning the expandable cushion of FIGS. 1 and 2 into a gap between a dental appliance and gum line, according to an embodiment of the invention;

FIG. 5 is a side view illustration of a dental appliance removal tool having an alternative pistol grip actuation mechanism, according to another embodiment of the invention;

FIG. 6 is a perspective view of a dental appliance removal tool having multiple booster cushions, according to another embodiment of the invention;

FIG. 7A is a perspective view of one of the booster tubes of FIG. 6

FIG. 7B is a side elevation view of the booster tube of FIG. 7A, with a proximal end portion of the tube cut away to reveal the end connector;

FIG. 7C is a front end elevation view of the booster tube of FIGS. 7A and 7B;

FIG. 8A is a perspective view of a first actuation handle of the tool of FIG. 6, according to an embodiment of the invention;

FIG. 8B is a top plan view of the actuation handle of FIG. 8A;

FIG. 8C is a side elevation view of the actuation handle of FIGS. 8A and 8B;

FIG. 9 is a perspective view of the second actuation handle of the tool of FIG. 6, according to an embodiment of the invention;

FIG. 10 is a cross-sectional view on the lines 10-10 of FIG. 9, illustrating the breakaway mechanism built into the handle;

FIG. 11 is a perspective view of the breakaway part of the handle or lever arm of FIGS. 9 and 10;

FIG. 12 is a top plan view of the distal end part of the handle of FIGS. 9 to 11;

FIG. 13A is a perspective view of the center mount of the tools of FIGS. 1 to 4B and FIGS. 6 to 12, according to one embodiment;

FIG. 13B is a front elevation view of the center mount of FIG. 13A, illustrating the tubular chamber receiving bore;

FIG. 13C is a side elevation view of the center mount of FIGS. 13A and 13B, illustrating the handle or lever arm pivot connection holes;

FIG. 14 is a perspective view of the pressure chamber assembly of FIG. 6, according to one embodiment;

FIG. 15 is a longitudinal cross-sectional view of the pressure chamber assembly along lines 15-15 of FIG. 14;

FIG. 16 is a perspective view of a pressure pad of the actuation mechanism of FIGS. 6 to 15, according to an embodiment of the invention;

FIG. 17 illustrates insertion of the cushions on the booster tubes of FIG. 6 inserted at different positions between the gum line and an implant mounted dental appliance, prior to expansion of the cushions.

FIG. 18 is a flow diagram illustrating a method of removing a dental appliance using one of the dental appliance tools of FIGS. 1 to 17, according to an embodiment of the invention;

FIG. 19 is a side elevation view of a modified activation handle and pressure chamber assembly of a dental appliance tool, according to another embodiment;

FIG. 20 is a front perspective view of the assembly of FIG. 19, illustrating ports for connecting the pressure chamber to the booster tubes of FIGS. 6 to 17;

FIG. 21 is a longitudinal cross-sectional view of the assembly of FIGS. 19 and 20;

FIG. 22 is an exploded view illustrating separated parts of the assembly of FIGS. 19 to 21;

FIG. 23 is a perspective view of a dental appliance removal system according to another embodiment;

FIG. 24 is a top plan view illustrating the booster tubes and associated tubing and connection manifold for connecting the booster tubes to the pressurized fluid source of FIG. 23;

FIG. 25 is an expanded perspective view of the booster tubes of FIGS. 23 and 24;

FIG. 26 is an expanded top plan view illustrating the connection manifold of FIG. 24 in more detail;

FIG. 27 is a perspective view of the connection manifold;

FIG. 28 is a longitudinal cross-section view on the lines 28-28 of FIG. 26 illustrating the passageways through the manifold;

FIG. 29 illustrates the pressurized fluid supply of the system of FIG. 23 along with flattened cushions of the booster tubes ready for insertion;

FIG. 30 illustrates the inflation device or pressurized fluid supply of FIGS. 23 and 29 with a user actuating the device;

FIG. 31 illustrates placement of the cushions for removal of a dental appliance and the pressure gauge of the inflation device when pressure is applied to expand the cushions; and

FIG. 32 is a flow diagram illustrating one embodiment of a method of operating the system of FIGS. 23 to 31.

### DETAILED DESCRIPTION

Certain embodiments disclosed herein provide for a dental appliance removal tool or system comprising one or more booster tubes each having an expandable portion or cushion at its distal end configured for insertion between a gum line and dental appliance such as a full or partial denture or other dental prosthesis, an inflation device for supplying pressurized fluid to the booster tube to expand the cushion, and an actuation mechanism for actuating the inflation device. When the cushion or tip portion of the booster tube is inserted between a gum line and a denture, and pressurized fluid is supplied to the booster tube, the cushion expands radially at a distal end to increase the circumference of the tube and apply pressure to the gum line and denture, releasing the denture from the gums or an implant support. The cushion may have a tapered, thin insertion tip at the distal end to allow for easy insertion into a small gap between a gum line and the denture, as well as additional positioning mechanisms to ensure that the cushion is positioned properly and expands to loosen or release the dental appliance once actuated. In one embodiment, the inflation device comprises a fluid chamber in communication with the booster tube which is inserted into an actuation mechanism such as a lever arm which applies pressure to compress the fluid chamber, causing pressurized fluid to flow to the distal end of the tube and expand the cushion.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The dental appliance removal tool or system described herein provides for easy removal of a dental appliance from the gums, tooth mount, or one or more implants or tooth roots without requiring the use of significant or abrupt force by a dental professional. The even application of force by the expanding tube to the dental appliance and the gums helps to ensure that the user of the dental appliance feels little or no pain and does not have their mouth, jaw or head moved in any significant degree. In one embodiment, the expandable tip portion or cushion expands into a smooth, cylindrical profile of circular cross-section when inflated, causing little or no discomfort to the user when pressure is applied.

The dental appliance removal tool or system may be used to remove any type of dental appliance including an implant-supported or root supported dental appliance, and may be useful for removing a denture, partial, retainer, removable bridge, or any other dental appliance which is retained in the mouth by adhesive, friction or tooth mount or implant support.

The details of several embodiments of a dental appliance removal tool or system provided below provide further explanations of the features and benefits of the tool, as well as additional features which provide ease of use to the dental professional and comfort to the user during the removal process.

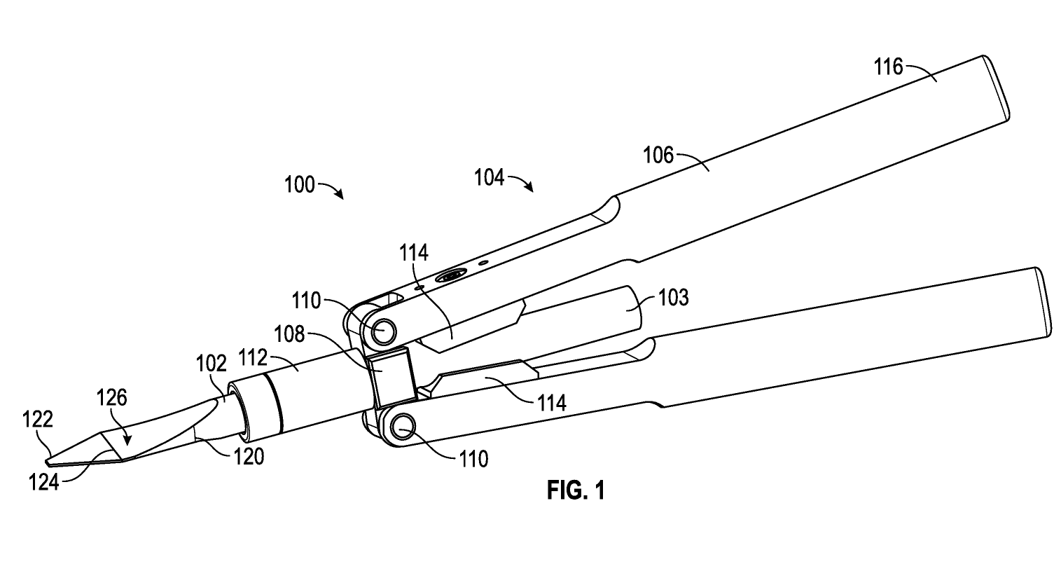

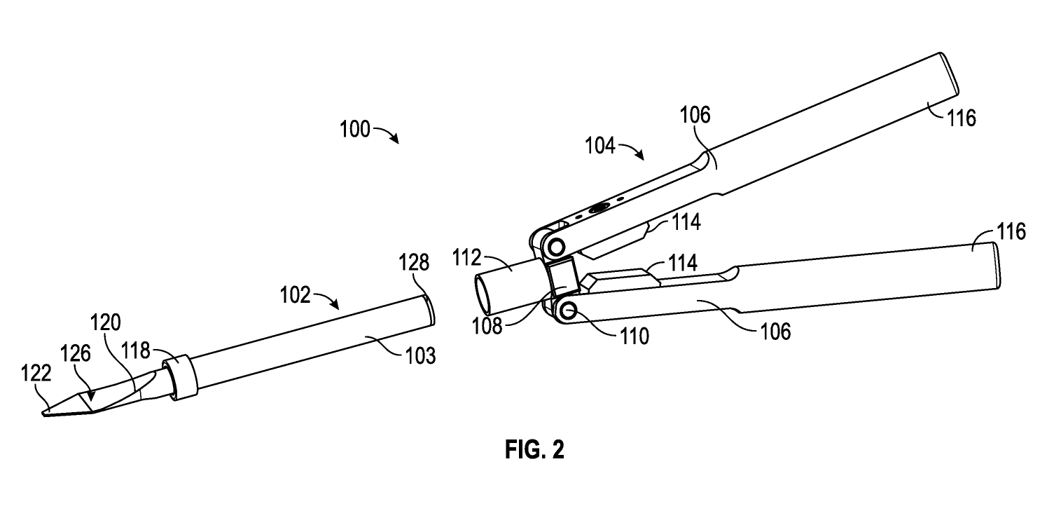

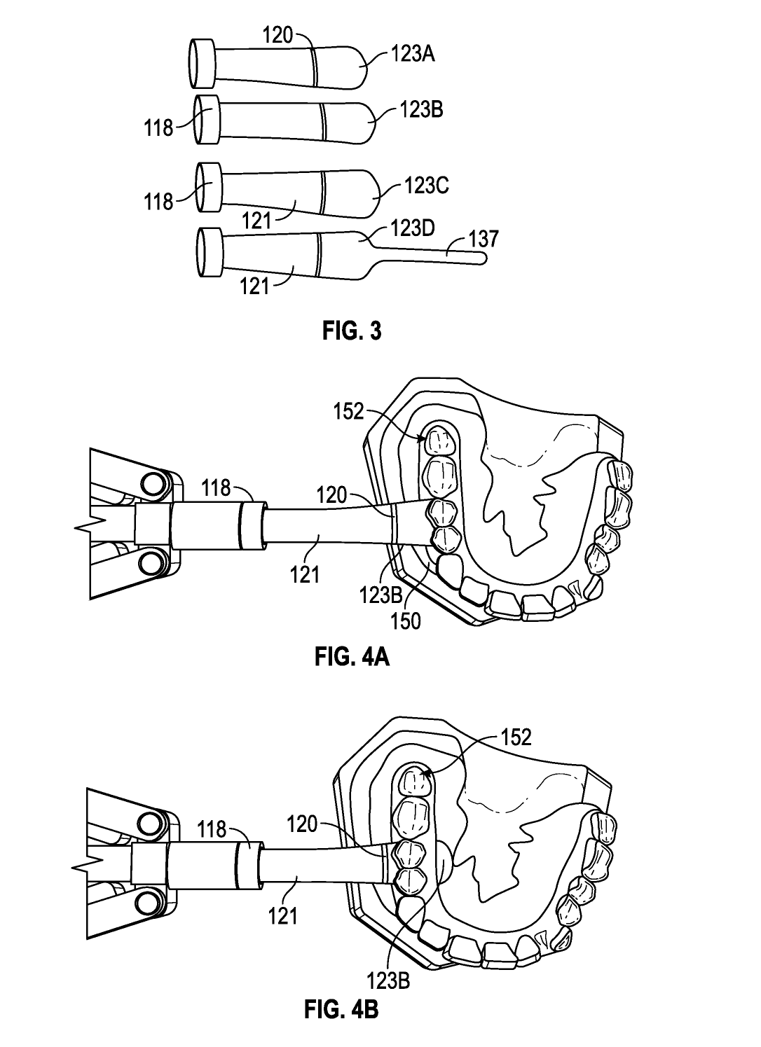

FIGS. 1 and 2 illustrate one embodiment of a dental appliance removal tool or assembly 100. Tool 100 has a booster tube 102 with an expandable distal end portion or cushion 126, an inflation device or fluid chamber 103 connected to the proximal end of booster tube 102, and an actuation mechanism 104 for compressing fluid chamber 103 to expand the cushion 126. FIG. 3 illustrates booster tubes 121 having inflation portions or cushions 123A, 123B, 123C and 123D of different shape from the cushions 126 of FIGS. 1 and 2 which may be connected to fluid chamber 103 in place of booster tube 102, as illustrated in FIGS. 4A and 4B.

In this embodiment, the actuation mechanism comprises a pair of lever arms 106 which are pivotally connected at their forward ends with a central tube mount 108 via hinges or pivot pins 110 extending transversely through parallel openings at opposite ends of the central tube mount and aligned openings at the forked ends of the respective lever arms. Fluid chamber 103 is inserted through a positioning sleeve 112 of actuation mechanism 104 and through an opening in the central tube mount 108 extending transverse to the openings which receive pivot pins 110, and then extends between the two lever arms 106 such that the lever arms can be pivoted toward each other and apply pressure to opposing portions of expandable tube 102. Pressure pads or jaws 114 may be attached to an interior surface of the lever arms 106 to apply pressure more evenly to the expandable tube 102 when the lever arms are urged together. The lever arms 106 have hand grips for manual actuation by a dental professional.

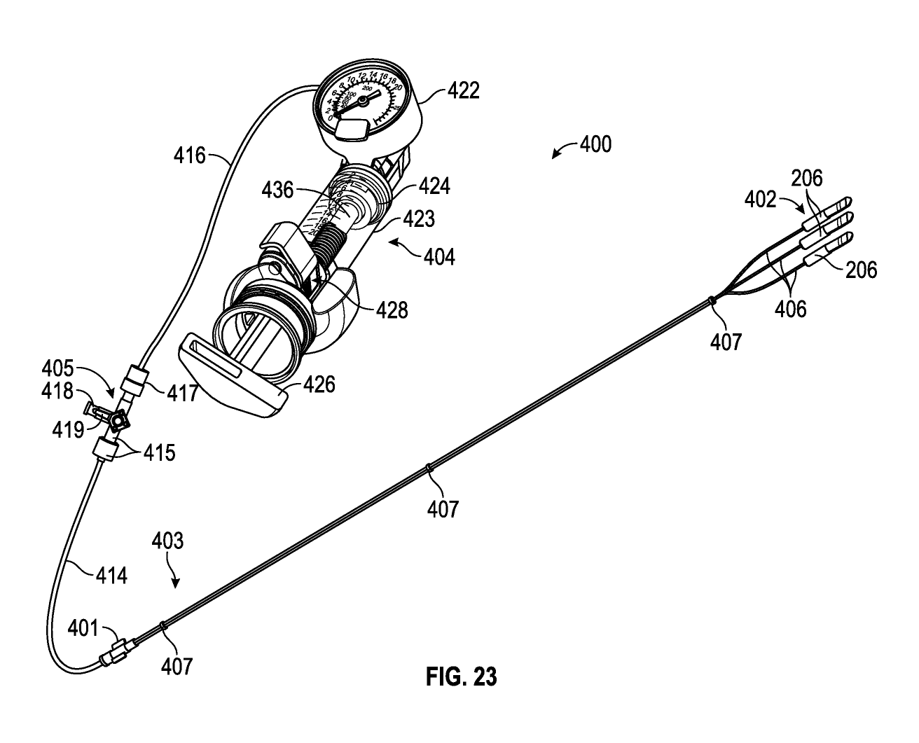

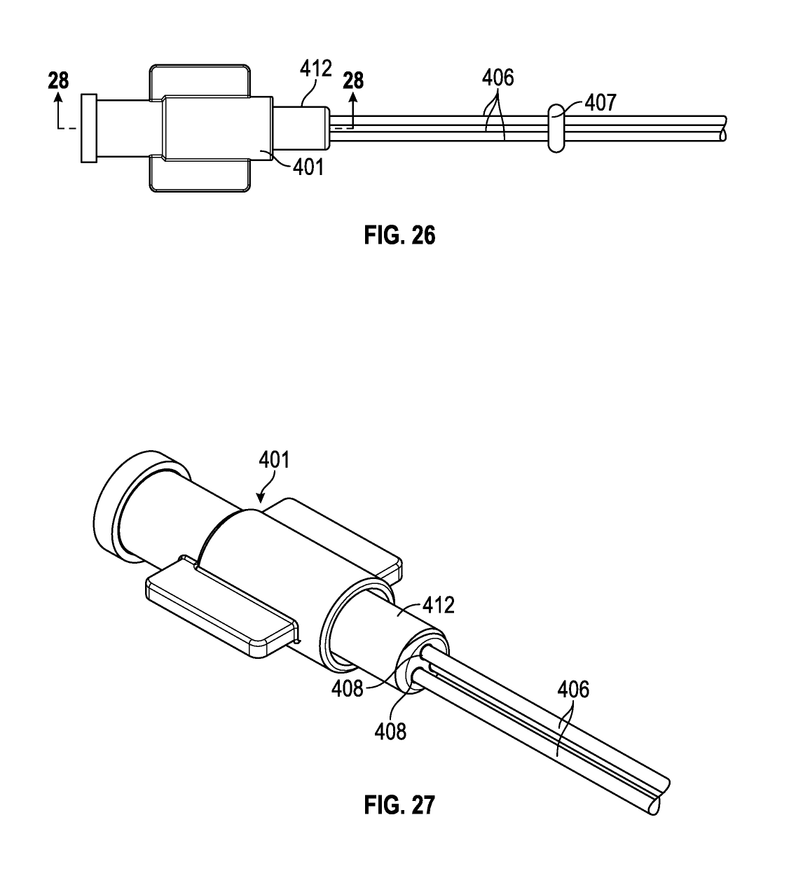

In the embodiment of FIGS. 1 to 4B, the actuation mechanism 104 is a pair of opposing lever arms, but one of skill in the art will appreciate that other actuation mechanisms may be used which perform the same function of applying pressure to the fluid chamber in order to expand the distal end portion of the booster tube. For example, in one embodiment, the actuation mechanism may be a movable stopper placed in the rear end of the expandable tube that is simply depressed by the dental professional to expand the distal end portion of the expandable tube. In another embodiment, pressure may be supplied from an inflation device such as a pump having a pressurized fluid output connected to the proximal end of the tube, as described in more detail below in connection with the embodiment of FIGS. 23 to 33.

FIG. 2 illustrates booster tube 102 and inflation device or pressure chamber 103 separate from actuator mechanism 106, prior to installation of the pressure chamber 103 into position between the jaws 114 of handles 116, as seen in FIG. 1. In one embodiment, inflation chamber 103 and booster tube 102 are formed integrally, and include a positioning ring 118 which surrounds a portion of the tube 102 with inflation chamber 103 extending from the opposite side of ring 118. Ring 118 is positioned to match up with the positioning sheath 112 to ensure that the expandable tube and inflation chamber extend sufficiently in length in both directions allow the lever arms 106 to actuate against the inflation chamber 103, and to allow the expandable tube to be easily inserted between the gum line and the dental appliance prior to actuation so that it can expand and separate the dental appliance from the implant.

An insertion tip 122 is formed at the distal end of cushion 126 and may be tapered to a point to allow the expandable tube 102 to be easily inserted into a normally small opening that exists between the dental appliance and the gum line of the user. In the embodiment illustrated in FIGS. 1 and 2, the insertion tip 122 is a flat, pointed tip which is generally not expandable in order to maintain a thin, flat shape that can be easily inserted into the small gap between the gum and dental appliance. In order to prevent the expansion of the insertion tip, a seal 124 may be formed across the cushion at the insertion tip to prevent the material in the expandable cushion from flowing into the insertion tip. Although the flat insertion tip 122 is pointed at its distal end in FIGS. 1 and 2, it may alternatively be of rounded shape as illustrated in FIGS. 3 and 4.

In one embodiment the expandable cushion is positioned between the gum line and the dental appliance so that it expands radially to loosen or separate the dental appliance from the implant. It may thus be considered an expandable portion 126, although other portions of the tube 102 also expand when pressure is applied by the lever arms.

A visible insertion line 120 is provided across the expandable tip portion 126 in one embodiment. This helps a dental professional insert the tip portion or cushion 126 a sufficient distance into the gap between the dental appliance and the gums for expansion in order to apply force to separate the dental appliance from the implant.

The fluid chamber 103 and expandable tube 102 may be filled with a liquid, gel, gas, or compressible solid that allows radial expansion of at least the expandable portion 126 when light pressure is applied to the fluid chamber. In one embodiment, the expandable tube is filled with a saline solution so that any accidental break or leakage of the expandable tube 102 will not pose any risk to the user or dental professional. However, other non-toxic liquids, gels, gases, or compressible solids may be used, such as purified or deionized water or air.

In one embodiment, the pressure chamber may be made of a plastic or other polymer material which is of sufficient thickness to withstand the pressure being applied by the lever arms. The booster tube may be made of the same or similar material but also thin enough to allow radial expansion particularly in the expandable portion or cushion 126. The pressure chamber and booster tube may be designed as a disposable portion of the tool to minimize the risk of contamination between uses and avoid the need to disinfect these parts as well.

In one embodiment, the pressure chamber is sealed by a stopper 128 at its rear end. Another important function of the positioning sheath 112 and the positioning ring 118 is to ensure that pressure chamber 103 is positioned as in FIG. 1 for actuation by the pressure pads 114 such that the pressure pads do not inadvertently impact into the stopper 128 and compromise the seal on the rear end of the pressure chamber. In another embodiment, the portion of pressure chamber 103 which is acted on by the pressure pads 114 is covered by a protective layer (not shown) which increases the strength of the expandable tube where repeated use may otherwise wear down the housing of the expandable tube.

In one embodiment, the length of booster tube 102 was around 1.5 inches while the combined length of the booster tube and pressure chamber 102, 103 was around 4.5 inches and the diameter of pressure chamber 103 was around 0.32 inches. The diameter of the tubular portion of booster tube 102 adjacent insertion sleeve 118 may be slightly less than that of portion 103, for example around 0.3 inches. In one embodiment, the thickness of the tube wall is approximately 0.008 inches, but a range of approximately 0.004 inches to approximately 0.016 inches would also be acceptable. The smaller end of this range includes the thickness of the flat tip 122 of cushion 126, which should be thin enough to be easily inserted into a small gap between the denture and the gums. These measurements are intended only for illustration purposes and may vary as understandable to one of ordinary skill in the art.

As noted above, FIG. 3 illustrates a set of booster tubes 121 having cushions 123A, 123B, 123C and 123D with tips of more rounded shape than booster tubes 102. The cushions 123A to 123D are also of different widths for selection by the dental professional based on width of selected spaces for insertion of the cushions, i.e. width of selected spaces between adjacent attachment assemblies or abutments of the dental appliance to be removed. Cushions 123A, 123B, and 123C are of increasing width. Cushion 123D has a long, narrow diameter extension 137 extending from the end of the insertion tip 123D. In this embodiment, the tip of cushion 123D is not sealed, so that extension 137 is expandable. This embodiment may be used for insertion into spaces between adjacent dental attachment assemblies or abutments which are too narrow for insertion of the flat but wide insertion tip.

FIGS. 4A and 4B illustrate a method of inserting the expandable cushion of a booster tube into the gap between the gum and dental appliance, according to one embodiment. Booster tube 121 with cushion 123B is shown in this example, but the procedure is the same regardless of whether booster tube 102 or any of the booster tubes 121 are used, or booster tube 102 of FIGS. 1 and 2 is used. In FIG. 4A, only the insertion tip has been inserted between the gum 150 and dental appliance 152, and the insertion line 120 is still clearly visible and spaced a visible distance from the edge of the dental appliance. FIG. 4B, however, shows the completed insertion configuration where the expandable tube has been inserted sufficiently into the gap such that the insertion line 120 is lined up with the edge of the dental appliance and the flattened tip protrudes from under the inner edge of dental appliance 152. Once this position is reached, the dental professional expands the end portion 126 to urge the appliance away from the gum. By using this alignment feature, the dental professional can position the cushion 126 between the gum and the appliance so that expansion of the cushion tends to separate the dental appliance from the implant or other support.

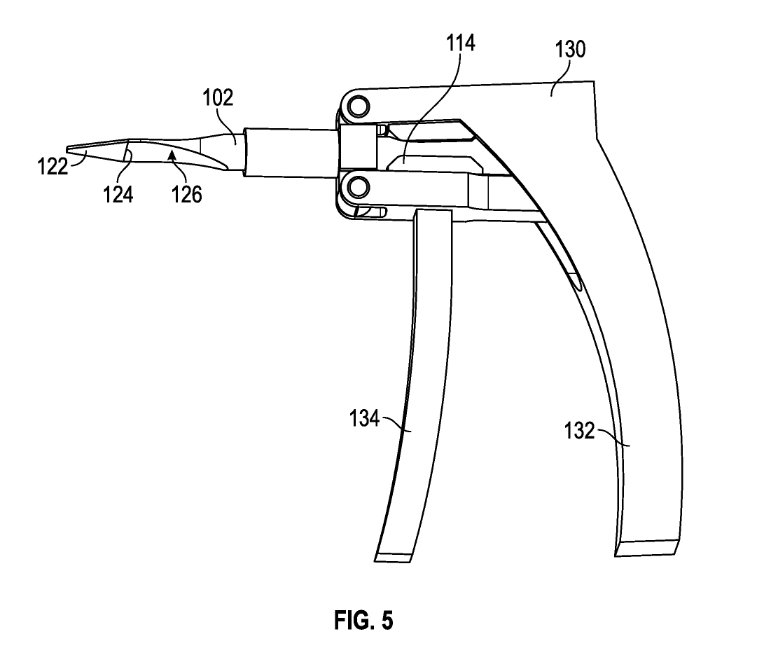

FIG. 5 illustrates one alternative embodiment of an actuation mechanism 135 in the form of a pistol grip lever arm, with the tubular pressure chamber 103 engaged between jaws 114 of the pistol grip mechanism. Other parts of this embodiment are identical to those of FIGS. 1 and 2, and like reference numbers are used for like parts as appropriate. The pistol grip mechanism includes an actuation housing 130 with a downward extending lever arm or handle 132 which is gripped by a hand of the dental professional. The dental professional then uses his or her fingers to actuate the opposing trigger or lever arm 134. A unique feature of the pistol grip lever arm is that actuation of lever arm 134 not only compresses the expandable tube, it also advances the expandable tube forward and away from the housing 130. Thus, a dental professional does not need to manually push the entire tool forward when inserting the insertion tip into the user's mouth and can instead do so by continually depressing the pistol lever arm 134. Any selected booster tube may be used in this embodiment.

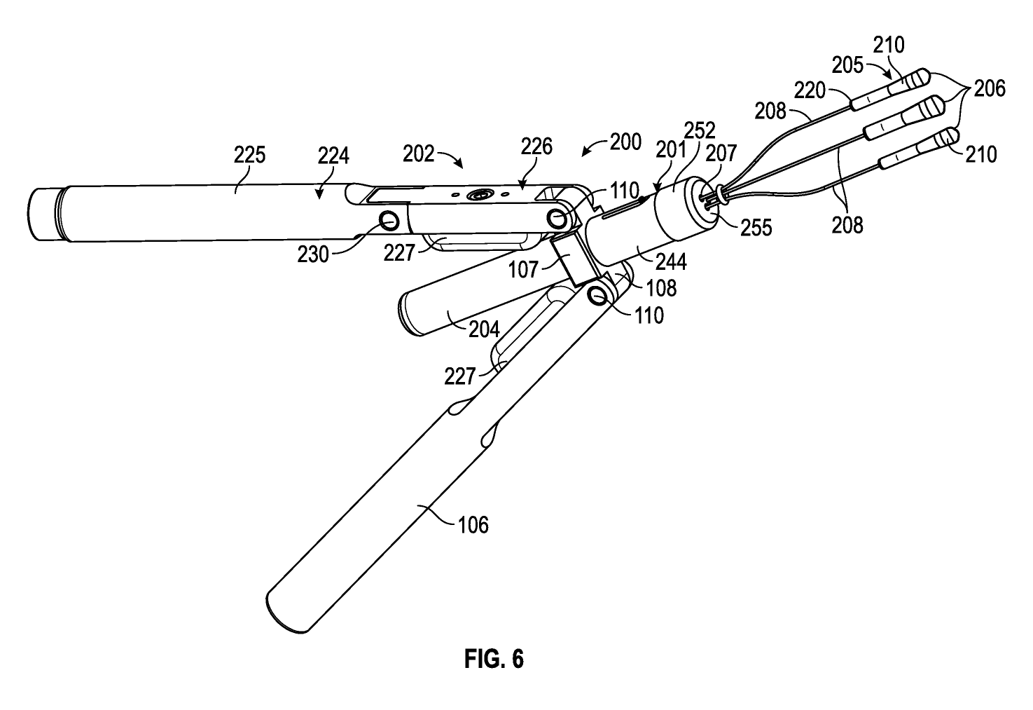

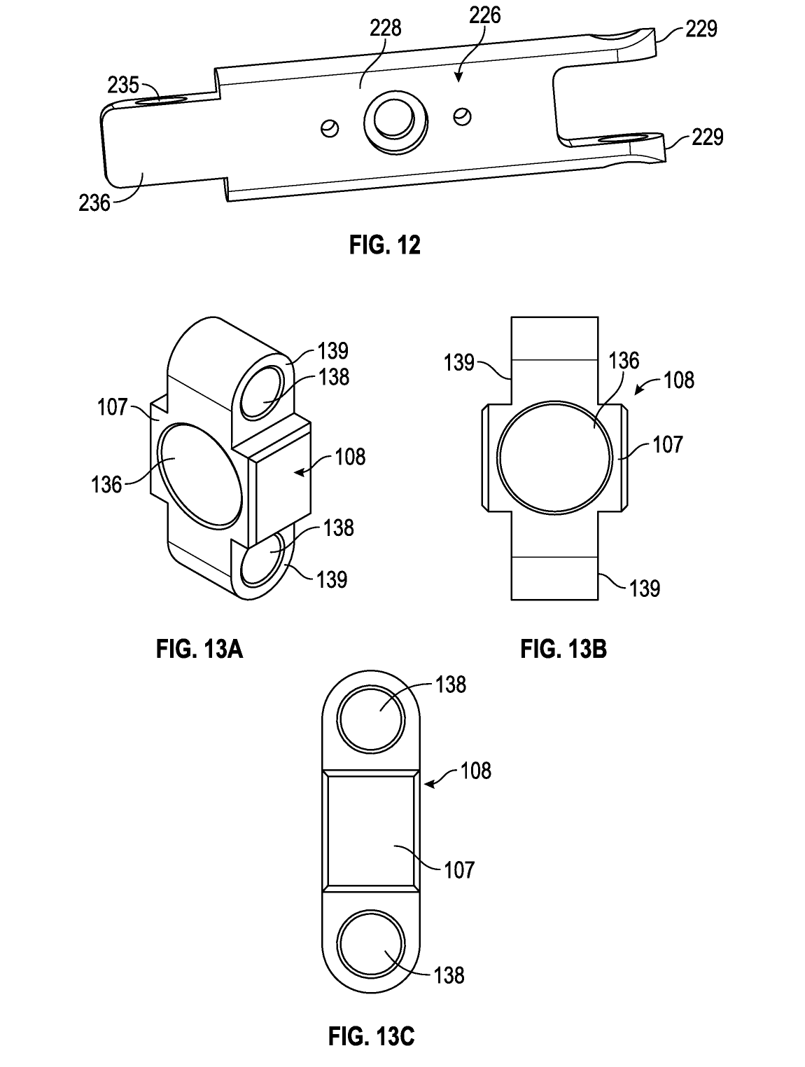

FIGS. 6 to 18 illustrate a dental appliance removal tool or assembly 200 according to another embodiment. This tool has some parts which are similar or identical to parts of the first embodiment of FIGS. 1 to 4B, and like reference numbers are used for like parts as appropriate. Tool 200 basically comprises an actuation mechanism 202, an inflation device or pressure chamber assembly 201 including compressible, fluid filled pressure chamber 204, and a booster assembly 205 of three booster tubes 206 connected to pressure chamber outlets 207 via tubing 208. Although three booster tubes are illustrated in FIG. 6, a greater or a lesser number of booster tubes may be provided and connected to the pressure chamber in a similar manner, as discussed in more detail below. Booster tubes 206 are similar in shape to the booster tubes 121 with tips 123A, 123B and 123C shown in FIG. 3, and have expandable portions or cushions 210 at their distal ends. The smaller size tubing or connection hoses 208 give the dental professional more room and flexibility in positioning the cushions.

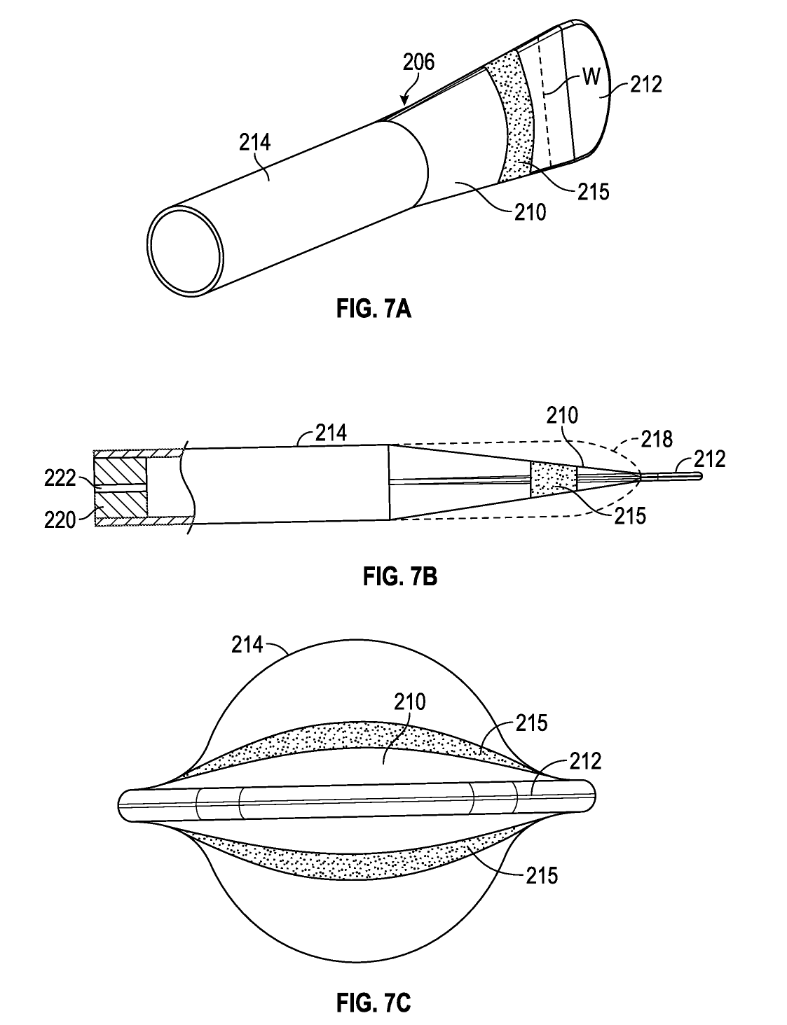

FIGS. 7A to 7C illustrate one of the booster tubes of booster assembly 205 in more detail. As illustrated, booster tube 206 has a tubular portion 214 of uniform diameter extending from its proximal end up to expandable portion or cushion 210 which tapers gradually down to flattened, sealed tip portion 212. As in the previous embodiments, a visible positioning or stop line 215 is provided across the cushion 210 to help the practitioner in inserting and positioning the cushion properly prior to inflation. Dotted line 218 illustrates the fully inflated condition of cushion 215. Booster tube 205 is open at its proximal end. Since the diameter of tubular portion 214 is greater than that of the tubing 208 which connects the tube 215 to the fluid filled chamber 204, a Luer connector or plug 220 is sealably engaged in the end of tube 215 as illustrated in FIGS. 6 and 7B and has a tapered through bore 222 for leak-free engagement with a mating end portion of tubing 208.

In one embodiment, the three booster tubes 206 may be of similar dimensions and made of similar materials to booster tube 102 of the previous embodiments. However, one or all of the tubes may have cushions 210 of different widths W for fitting in gaps of different widths between adjacent dental abutments or natural fixtures protruding from the jaw above the gum tissue. In the booster assembly of FIG. 6, the cushion of central booster tube has greater transverse width W than the other booster tubes. In one example, the central cushion has a width of around 10 mm while the two outer cushions have widths of around 8 mm. Other cushions may be of smaller widths for smaller width spaces between dental implant components or between a dental implant component and natural fixture or tooth root. In practice, a supply of different booster tubes of different tip widths varying from around 5 mm to 16 mm may be provided, and the dental practitioner may choose appropriate booster tubes to attach to the tubing 208 based on the width of selected gaps or spaces for cushion insertion. This provides increased leverage for removal of a dental appliance retained by an implant or by adhesive, friction or tooth mount.

The thickness of cushion 210 and tip 212 when the cushion is pressed flat may be similar to that of dental floss or super floss. The average height increase from the uninflated condition to the inflated condition of the cushion shown in dotted outline in FIG. 7B in one embodiment was around 0.5 mm to 2 mm. This depends on the amount of bone recession that the patient may have experienced from the time the prosthesis was first created or re-fabricated. It is rare to have a gap of 2 mm that the cushion must fill. A more typical range is 0.5 mm to 1 mm. As the cushion is inflated, it comes into contact with the prosthesis and starts applying force to the prosthesis and the gingival tissue. It normally requires about 0.2 mm of additional vertical displacement to release a male retention member of a denture attachment system from a mating implant, root, or bar mounted abutment once the rest of the gap or space is taken up by the inflation of the cushion.

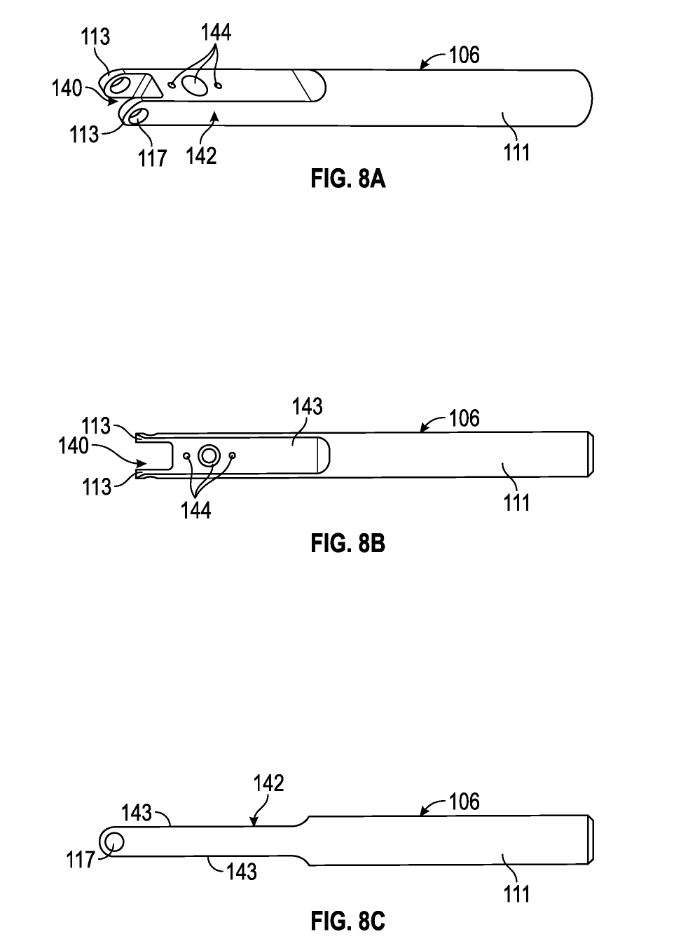

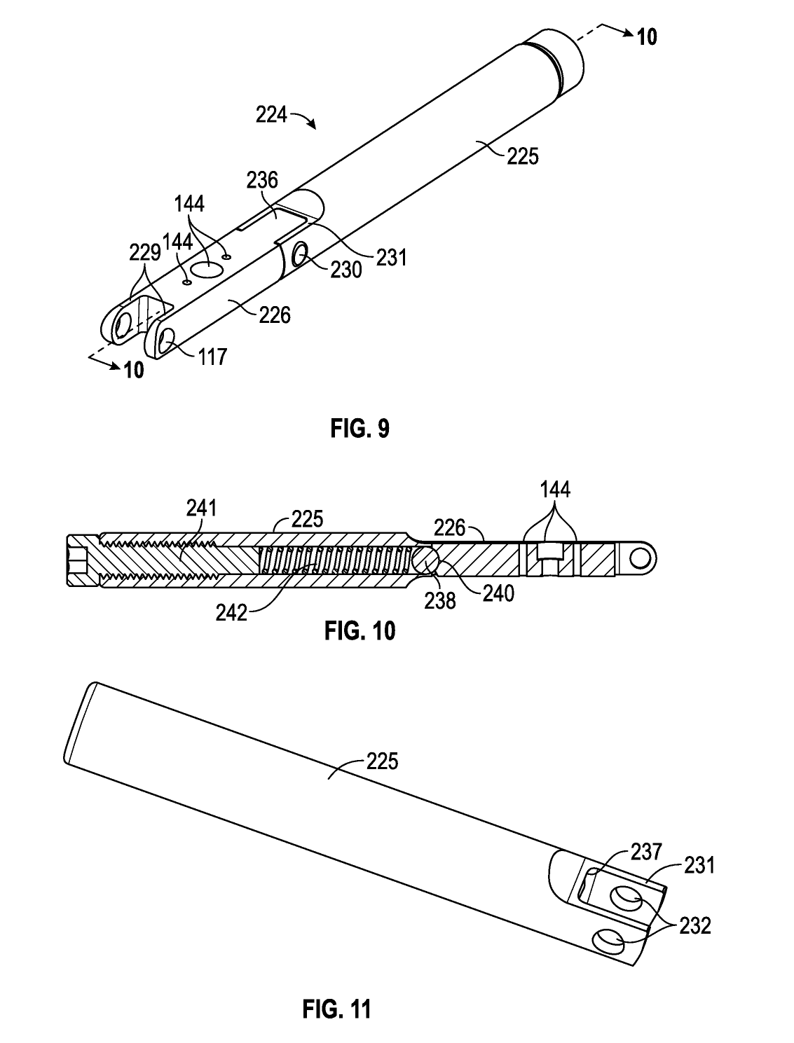

Parts of the lever arm actuator mechanism 202 of FIG. 6 are illustrated in more detail in FIGS. 8A to 13C. The actuator mechanism is similar to that of the first embodiment and has two lever arms 106, 224 pivotally mounted on center mount 108. However, unlike the first embodiment, the lever arms are not identical. Arm 106 is identical to one of the arms in the first embodiment, while lever arm 224 has first and second breakaway members 225, 226, as described in more detail below in connection with FIGS. 9 to 12. Opposing pressure pads 227 similar to pressure pad 114 of the first embodiment are attached to the respective lever arms.

FIGS. 8A to 8C illustrate various views of lever arm 106. As illustrated, lever arm 106 has a larger diameter handle portion 111 and a pressure pad screw mount 142 of reduced dimensions terminating in spaced ends 113 forming a pivot bracket or hinge connector for receiving the respective end portion 139 of mounting block 108. Aligned holes 117 in end flanges 113 are positioned for alignment with hole 138 in mounting block 108. When the actuation mechanism is assembled, pivot pin 110 extends between holes 117 and is rotatably engaged in hole 138 to allow pivoting of the respective lever arm, as best illustrated in the assembled views of FIGS. 1 and 2 (in the first embodiment) and in FIG. 6 showing the assembled tool of this embodiment. Pressure pad screw holes 144 for mounting one of the pressure pads 227 extend through the pressure pad mounting portion 142 of lever arm 106 between opposite flat faces 143, as illustrated in FIGS. 8A and 8B. In one embodiment, the length of lever arm 106 was around 5 inches, and the length of the arm portion of reduced dimensions including the pressure pad mount 142 and the hinge mount 140 was around 2 inches. The diameter of the handle portion was around 0.5 inches and the distance between opposite flat faces of the pressure pad mount 142 was around 0.3 inches. The diameter of pivot pin mounting holes 117 was around 3/16 inch. The distance between end flanges 113 was around 0.3 inches. These measurements are intended only for illustration purposes and may vary as understandable to one of ordinary skill in the art.

FIGS. 9 to 12 illustrate the two part lever arm 224 in more detail. First breakaway member 225 acts as a handle for gripping when applying force to compress fluid chamber 103, while second breakaway member 226 is similar to the pressure pad mounting portion 142 of lever arm 106. Member 226 has opposing flat faces 228 for mounting pressure pad 227 and spaced forward ends 229 forming a pivot bracket or hinge connector for receiving the respective end portion 139 of mounting block 108. Aligned holes 117 in the end flanges are positioned for alignment with hole 138 in mounting block 108 with pivot pin 110 extending through the aligned holes.

As illustrated in FIGS. 9, 11 and 12, the breakaway members 225, 226 of lever arm 224 are pivotally connected via pivot pin 230 extending through openings 232 in the forked inner end 231 of breakaway member 225 and the aligned bore 235 in the mating extension 236 of breakaway member 226. As best illustrated in FIG. 10, pivoting movement between these parts is restricted by internal ball 238 biased against an opposing indent 240 at the inner end of member 226 by spring 242 mounted inside breakaway member 225. In the illustrated position, ball extends across the junction between extension 236 and the opposing end face 237 of member 225, preventing pivoting movement of member 226 about pivot connection 230. The biasing spring force is controlled by screw 241 engaged in the outer end of member 226. Thus, breakaway members 225, 226 are held rigidly together with actuation of handle 225 pivoting the lever arm inwards to apply pressure to the fluid chamber, unless the force applied by a user gripping breakaway member or handle 225 exceeds the spring biasing force. In that case, handle pivots down and breaks away from member 226, releasing the force applied by lever arm 224. This limits the pressure applied to inflate the cushions, reducing the risk of patient discomfort and potential damage to the cushions.

FIGS. 13A-13C illustrate various views of the central tube mount or mounting block 108. FIGS. 13A and 13B illustrate opening 136 extending through the central portion 107 of block 108 for receiving pressure chamber 204 and FIGS. 13A and 13C illustrate parallel top and bottom hinge openings 138 extending through opposite end portions 139 of the block in a direction transverse to opening 136 for receiving hinge pins 110. In one embodiment, the height of the block between the outer ends of end portions 139 was around 1 inch while the width in the direction transverse to openings 136 and 138 was around 0.5 inches. The diameter of opening 136 was between 0.37 and 0.39 inches. The diameter of each hinge opening 138 was around 3/16 inch and the length between opposite ends of openings 136 and 138 was around 0.28 to 0.32 inches. The center to center distance between openings 136 was around 0.7 inches. These measurements are intended only for illustration purposes and may vary as understandable to one of ordinary skill in the art.

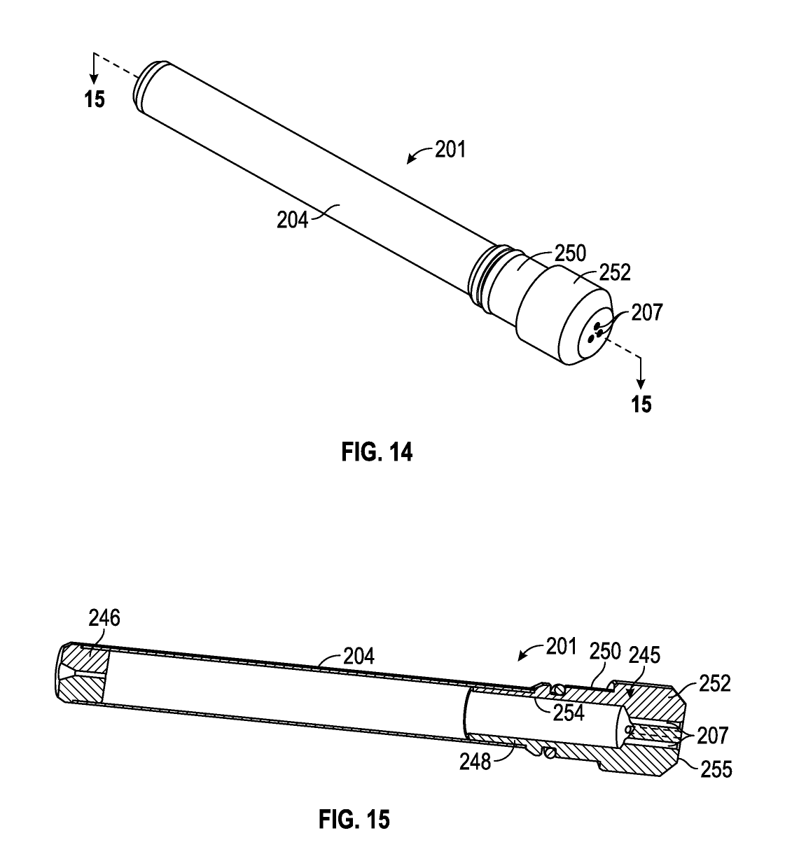

FIGS. 14 and 15 illustrate the pressure chamber assembly 201 in more detail, apart from adapter tube or sleeve 244 which is seen in FIG. 6. Assembly 201 also comprises tubular pressure chamber 204, pressure chamber interface or connector 245, and chamber end plug 246. End plug 246 engages in the rear end of chamber 204 and seals the chamber after filling with a suitable fluid, such as sterilized water or saline. Interface or connector 245 is of stepped diameter and has an end portion 248 sealably engaged in a forward end of chamber 204, central portion 250, and head portion or connection manifold 252. Bore 254 extends from the inner end of connector 244 up to head portion 252, and three small Luer taper bores or outlets 207 extend from the inner end of bore 254 up to end face 255, for sealing engagement over the ends of tubing 208, as illustrated in FIG. 6. A greater or lesser number of bores 207 may be provided in head portion 252, depending on the number of booster tubes required. Interchangeable pressure chamber interfaces may be provided with different numbers of bores 207, as well as only one bore as in the first embodiment, to allow the dental professional to decide how many cushions are needed to remove a dental appliance and to replace the interface. Adapter tube 244 has a similar function to positioning sleeve 112 of the first embodiment, and is placed over the central portion 250 of interface 245 before inserting pressure chamber 204 through the central opening 136 in center mount 208 until the end of sleeve 112 engages the outer end face of center part 107 as in FIG. 6. This ensures that pressure pads 227 engage the appropriate part of the compressible walls of pressure chamber 204 when the lever arms are actuated.

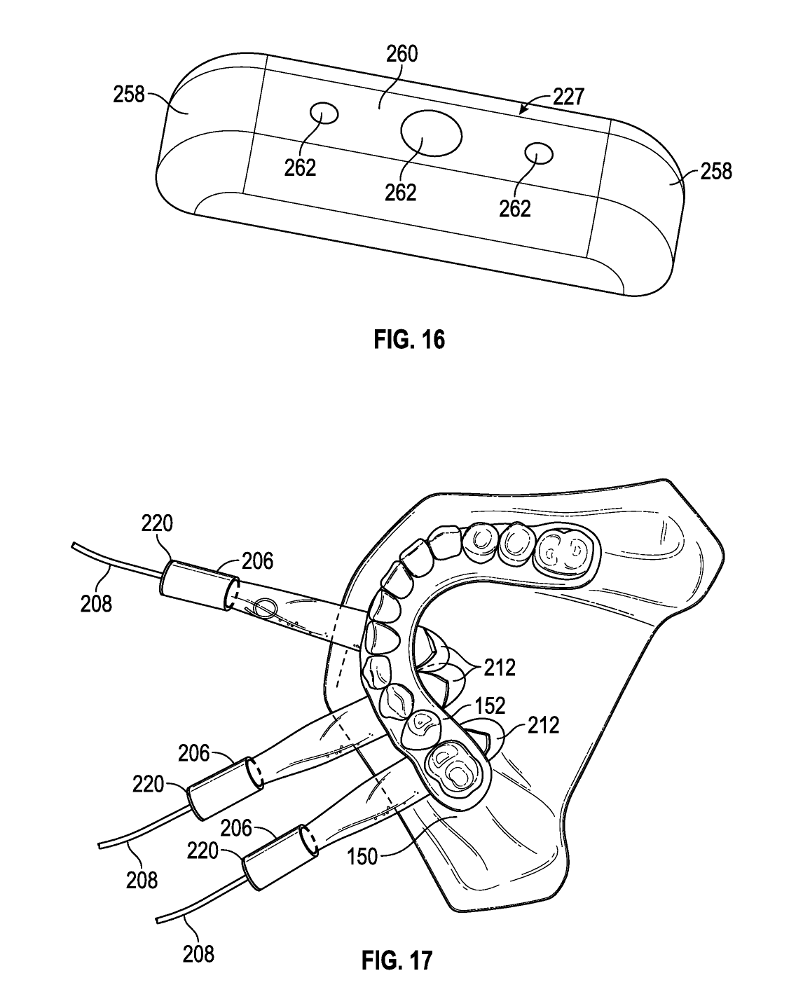

FIG. 16 is a perspective view of one of the pressure pads 227. As illustrated, each pad 227 is a substantially rectangular block of material having a flat inner face, opposite rounded ends 258 and an outer face 260 which engages the pressure chamber. Mounting screw or fastener openings 262 extend through the pad and are aligned with matching openings 144 in the mounting portion of lever arm 106 and breakaway member 226 of lever arm 224 for mounting the pressure pads. In one embodiment, the length of the pressure pad was around 0.8 inches, the width was around 0.4 inches, and the thickness or height was around 0.15 inches. The largest mounting screw opening had a diameter of around 0.32 inches while the smaller mounting screw openings had diameters of around 1/16 inch, matching the corresponding mounting screw hole diameters in the pressure pad mounting portion of the respective lever arm. These measurements are intended only for illustration purposes and may vary as understandable to one of ordinary skill in the art.

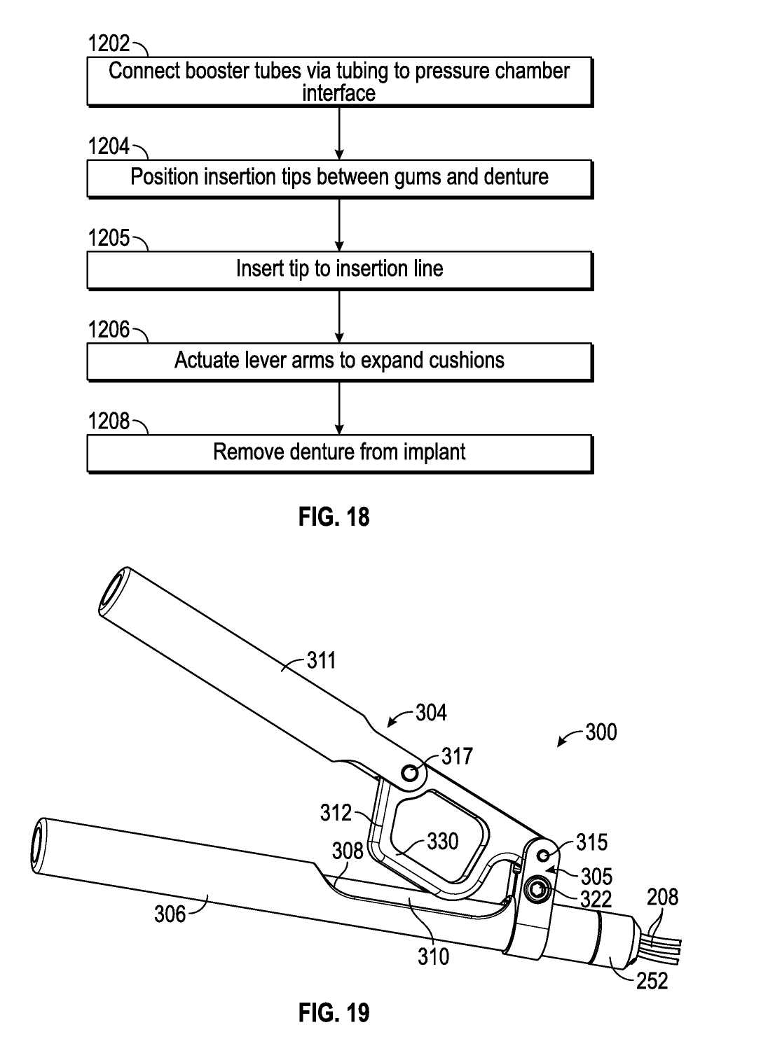

FIG. 17 illustrates insertion of the cushions 210 on the booster tubes 206 of FIG. 6 at different positions between the gum 150 and an implant mounted dental appliance 152, prior to expansion of the cushions. As illustrated, the flattened tip 212 of each tube has been inserted through the space and out of the inner side of the appliance, until the line 215 is substantially aligned with the outer edge of the appliance and the expandable cushion 210 is in position in the gap between the gum and appliance. FIG. 18 illustrates one embodiment of a method of removing a dental appliance from an implant with the dental appliance removal tool of FIGS. 6 to 17. First, the dental practitioner decides which size of booster tube cushions are needed, based on width of selected gaps, i.e. distance between two adjacent dental implant components, a dental implant component and adjacent tooth or natural fixture protruding above the gum tissue, or between two natural fixtures. In step 1202, the selected booster tubes are connected to the pressure chamber interface or manifold 245 via tubing 208 sealably engaged in Luer taper bores 207 as in FIG. 6. In step 1204, the tips 212 of cushions 210 are inserted into the spaces or gaps between the gum and dental appliance. In step 1205, insertion is continued until the tips 212 project out from the inner side of the appliance and the insertion line is located at the outer rim or border of the dental appliance, as illustrated in FIG. 17.

Now that the booster assembly 205 is properly positioned, the lever arms 106 and 224 of the actuation mechanism are actuated to force fluid out of chamber 204 and through tubing 208 to the booster tubes (step 1206), and the cushions radially expand into the expanded condition illustrated in dotted outline in FIG. 7B, applying force against the dental appliance and gum line. The force of the expanding cushions tends to separate the dental appliance from the implant abutment. The procedure may be repeated on the opposite side of the patient's mouth to release the part of the appliance on that side from the associated implants. Once the dental appliance is separated from the implants (or other attachment securing the appliance in the patient's mouth), the dental appliance is removed from the implant (step 1208).

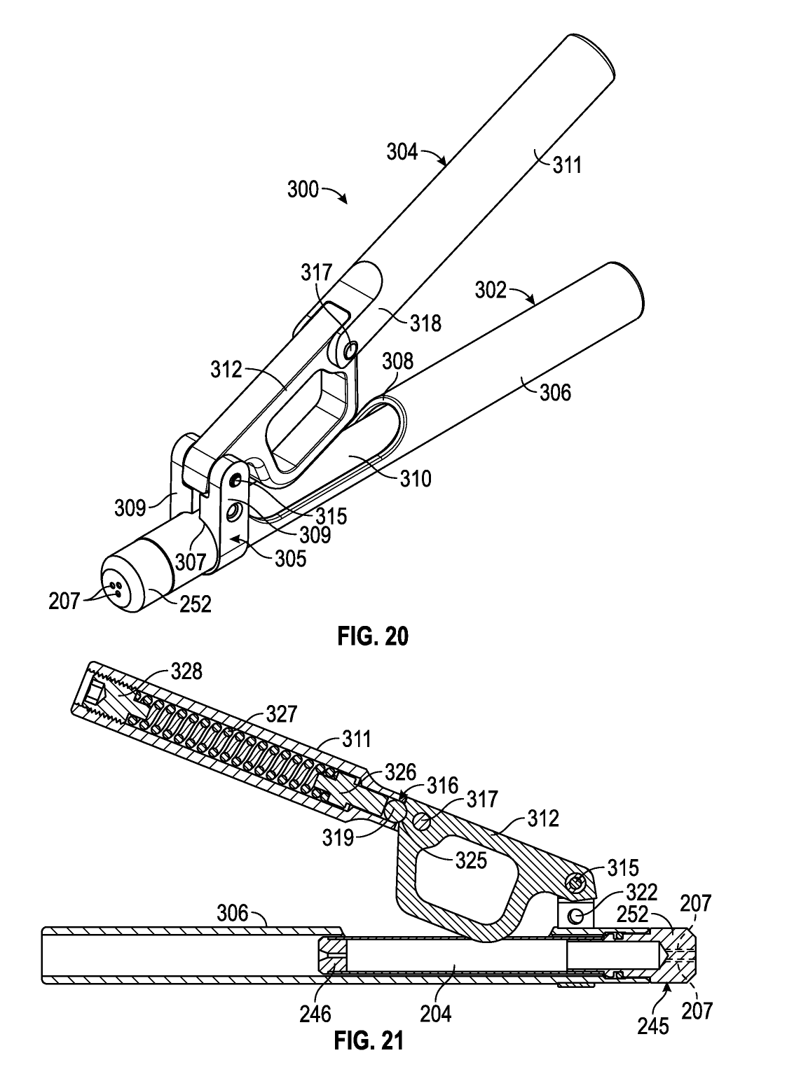

FIGS. 19 to 22 illustrate a modified embodiment of a dental appliance removal tool 300. The booster tubes are omitted in these figures but may be identical to booster tubes 206 of the previous embodiment. The actuator mechanism in this embodiment has only one lever arm 304 rather than two opposing lever arms as in the previous embodiments. As in the previous embodiment, any number of booster tubes 206 may be connected to a suitable pressure chamber interface via tubing 208.

The dental appliance removal tool of FIGS. 19 to 22 basically comprises lever arm 304, mounting block 305, pressure chamber assembly 302, and pressure chamber outer housing or shell 306. Tubular outer housing or shell 306 has a forward end portion 301 and an upper extended opening or slot 308. Pressure chamber assembly 302 is similar or identical to the pressure chamber assembly of the previous embodiment, apart from positioning sleeve 244 which is not needed in this case, and like reference numbers are used for like parts as appropriate. Assembly 302 comprises pressure chamber 204, rear end plug 246, and pressure chamber interface or manifold 245. Once these parts are assembled and pressure chamber 204 is filled, the rear end of chamber 204 is inserted into the forward end of outer shell 306 until the forward end portion 252 of interface 245 engages the forward end of shell 306, as seen in FIG. 21. In the illustrated example, interface 245 is shown with three Luer bores or inlets 207 as in the previous embodiment for connection to the ends of tubing 208 connected to the booster tubes, but alternative interfaces may be provided with a greater or lesser number of openings, depending on the desired number of booster tubes for dental appliance removal.

Mounting block 305 has a lower opening 307 which is open at its upper end, and a pair of arms 309 extending upward from opening 307. Threaded openings 320 extend through arms 309 transverse to opening 307. The shell 306 extends through lower opening 307 of mounting block 305 with the forward end of opening or slot 308 located adjacent the opposite or rear side face of block 305, as illustrated in FIG. 19. This positions the exposed portion 310 of pressure chamber 204 correctly, as described in more detail below. Once the pressure chamber is in the correct position, a bolt or screw fastener 322 extending through the mounting block openings 320 is tightened to secure the chamber 204 in opening 307. Aligned pivot pin openings 324 are provided adjacent the upper ends of arms 309.

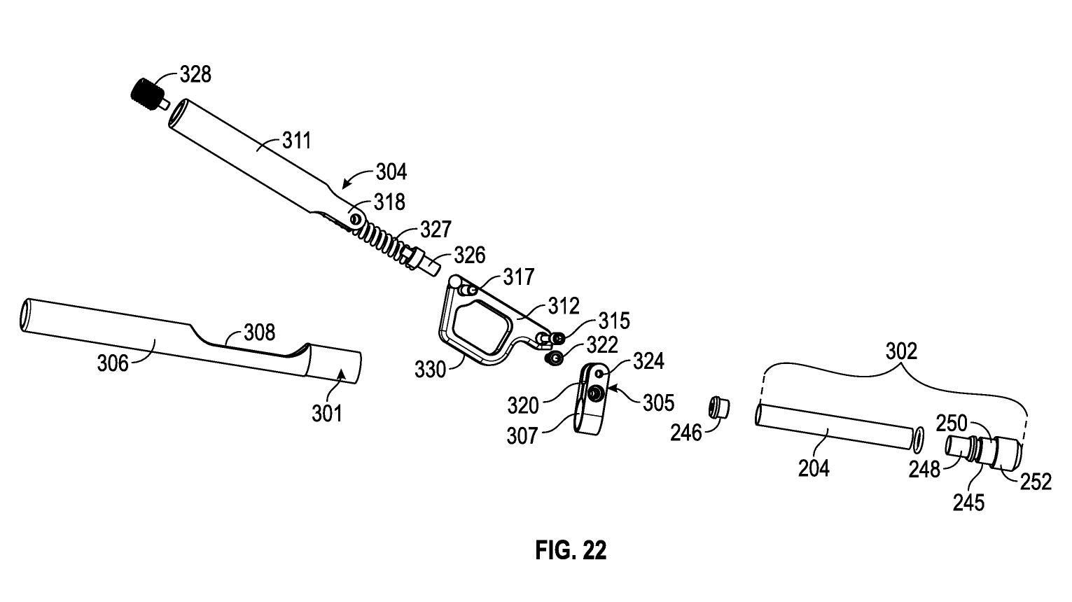

Lever arm 304 has a handle member 311 for gripping by the user and plunger or actuator 312 secured to the handle member 311 at one end and pivoted between arms 309 of mounting block 305 via pivot pin 315. As illustrated in FIG. 21, the connection 316 between lever arm 304 and actuator 312 is a breakaway connection similar to the breakaway between lever members 225, 226 of the previous embodiment, to limit the amount of force applied by actuator 312 to the exposed region 310 of the pressure chamber. Handle member 311 and actuator 312 are pivotally connected via pivot pin 317 extending through openings in the forked inner end 318 of handle member 311 and an aligned bore in a portion of actuator 312 engaged between the forks. As best illustrated in FIGS. 21 and 22, pivoting movement between these parts is restricted by internal ball 319 biased against an opposing indent 325 by plunger 326 biased against ball 319 by spring 327 mounted inside tubular handle 311. This prevents pivoting movement of handle 311 about pivot connection 317 unless the biasing spring force is exceeded. The biasing spring force is controlled by screw 328 engaged in the outer end of handle 311. As illustrated in FIG. 19, actuator 312 has a lower portion 330 which opposes the exposed portion 310 of the pressure chamber wall.

Operation of the dental appliance tool of FIGS. 19 to 22 will now be described in more detail. As in the previous embodiment, the dental practitioner will first determine the number and sizes of expandable cushions needed for removal of a patient's implant mounted dental appliance. The appropriate booster tubes are then attached to pressure chamber interface inlets 207, and the uninflated cushions are inserted in the selected spaces between the appliance and gums. The practitioner then grips shell 306 and lever arm handle 311, and urges the handle 311 towards the shell. Lower portion or plunger 330 of actuator 312 then engages and compresses the exposed portion 310 of the pressure chamber, forcing fluid out of chamber 204 and through tubing 208 to the booster tubes so that the cushions radially expand into the expanded condition illustrated in dotted outline in FIG. 7B, applying force against the dental appliance and gum line. The force of the expanding cushions tends to separate the dental appliance from the implant. The procedure may be repeated at different locations in the patient's mouth if needed. Once the dental appliance is separated from the implants (or other attachment securing the appliance in the patient's mouth), the dental appliance is removed from the implant.

FIGS. 23 to 32 illustrate another embodiment of a dental appliance or prosthesis removal tool or system 400 in which a similar or identical booster assembly 402 to the previous embodiments is connected to an inflation device 404 via a fluid pathway 403 including connection manifold 401 and three way valve 405 with Luer connections. In this case, the inflation device is a manually operated fluid pump rather than a lever actuation mechanism as in the previous embodiments. In other embodiments, the fluid pump may be automated or may be replaced by another pressurized fluid source. In one embodiment, the fluid used for inflation of the booster cushions is deionized or sterilized water. In one embodiment, the inflation device 404 and three way valve 405 are commercially available medical devices. In one embodiment, inflation device 404 may be a manual balloon catheter pump, such as the QL 2030PR Inflation Device manufactured by Atrion Medical Products, Inc. of Arab, Ala., and valve 405 is a three way valve with Luer connections designed for a medical fluid delivery system for a balloon catheter or the like, such as the H3RRC High Pressure three-way valve which is one of the Marquis® Series Stopcocks manufactured by Merit Medical of South Jordan, Utah.

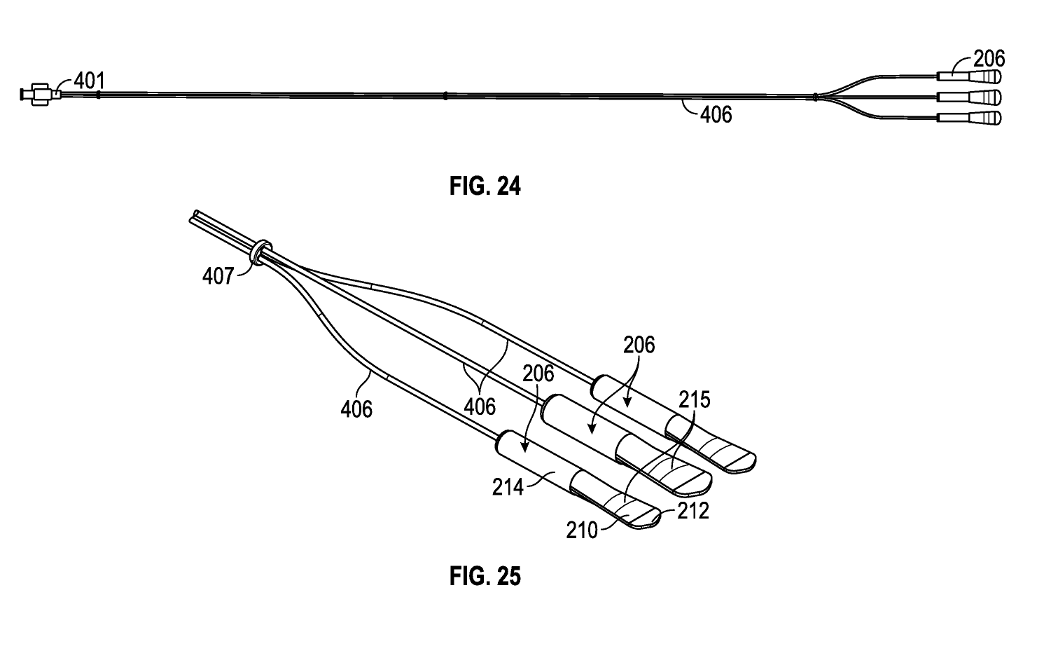

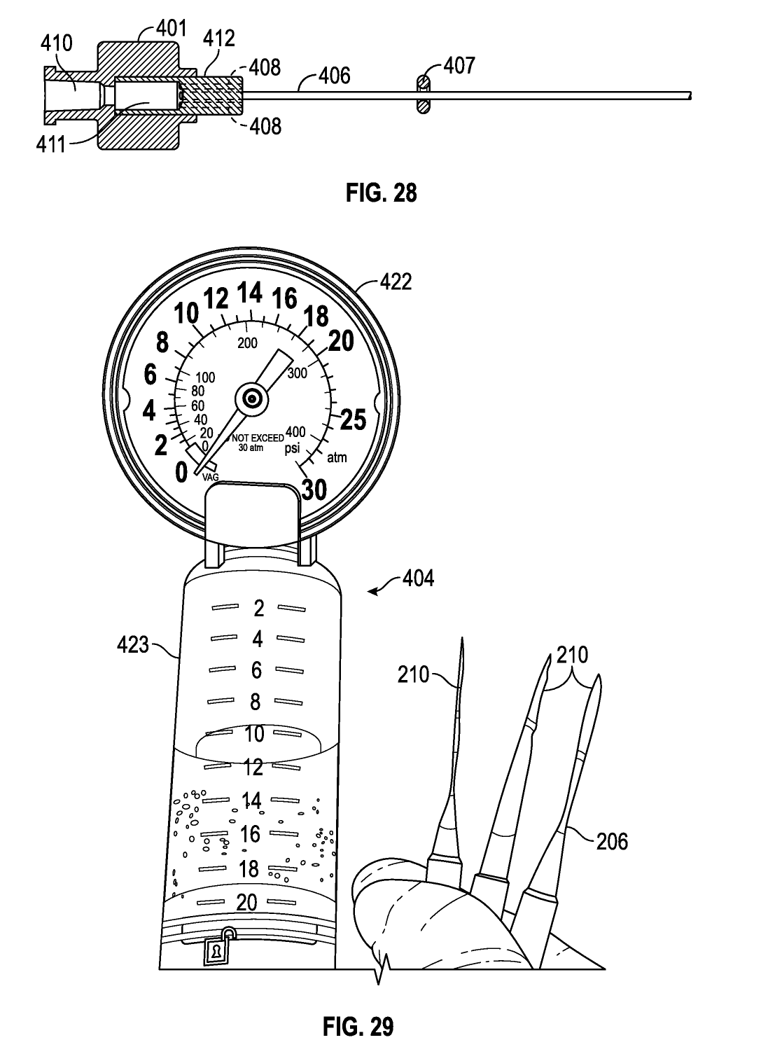

In the illustrated embodiment, the booster assembly 402 is similar or identical to booster assembly 205 of FIGS. 6 to 7C, and like reference numbers have been used for like parts as appropriate. Although three booster tubes 206 are illustrated, it will be understood that a greater or lesser number of booster tubes as well as booster tubes with inflatable cushions of different sizes or shapes may be connected to the inflation device via a suitable connection manifold, depending on the particular dental appliance to be removed. As illustrated in more detail in FIGS. 24 to 26, three separate hoses or lengths of tubing 406 extend from the booster assembly to booster connector or connection manifold 401, forming a first part of the booster path 403. The three lengths of tubing are held together by several resilient rings or other fasteners 407 and are connected at their proximal ends to booster connector or connection manifold 401. As best illustrated in FIG. 28, booster connector 401 has a first, tapered inlet port 410 at one end communicating with passageway 411 extending up to end portion 412 which has three ports or outlets 408 at the opposite end of connector 401 for connection to tubing or hoses 406. Manifold 401 may be made in two parts as illustrated in FIG. 28, or in one piece. Interchangeable booster connection manifolds with different numbers of outlets may be provided to allow for different numbers of booster tubes to be connected to the inflation device.

A first flexible hose 414 or tubing extends from booster connector inlet 410 to a first Luer fitting 415 of the three way valve 405, and second hose 416 extends from Luer fitting 417 to the pressurized fluid outlet of inflation device or pump 404. The hoses 414, 416 have appropriate rotating Luer connectors at their ends for sealing engagement with the Luer fittings at aligned outlet of the three way valve. The third outlet 418 of three way valve 405 is a vent outlet or pathway. Direction of flow through the three way valve is determined by the position of off lever 419. In FIG. 23, off lever 419 points to the vent pathway, closing the vent outlet 418 so that fluid flows in an inflation path through the valve from the inflation device to the booster tubes.

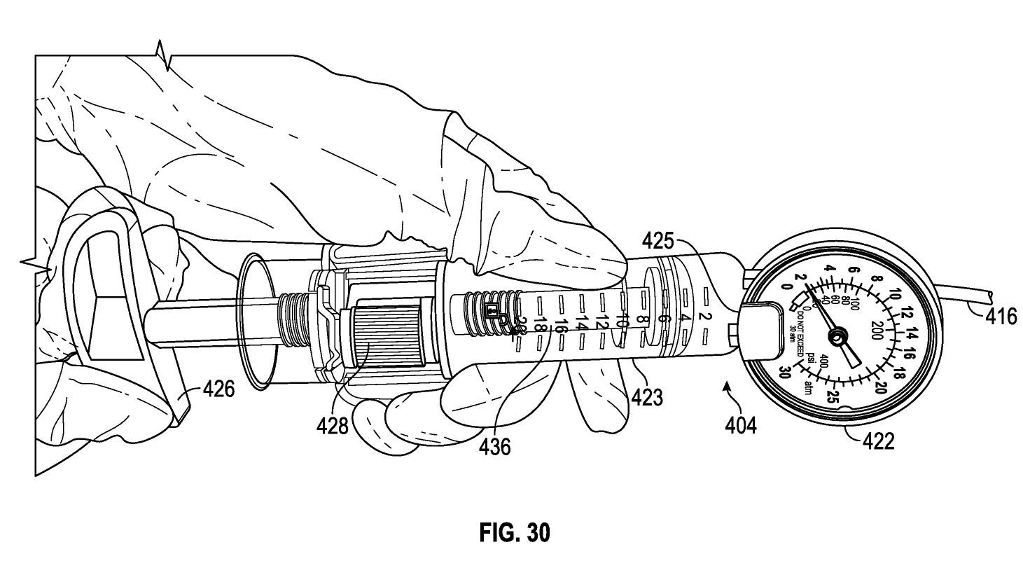

As best illustrated in FIGS. 29 and 30, inflation device or pump 404 has a pressure gauge 422 at one end and comprises a cylinder or barrel 423 forming a pressure chamber in which a piston or plunger 424 is sealably mounted for sliding movement towards and away from the outlet end 425 of the chamber. Piston rod 436 extends from piston 424 and is connected to handle 426.

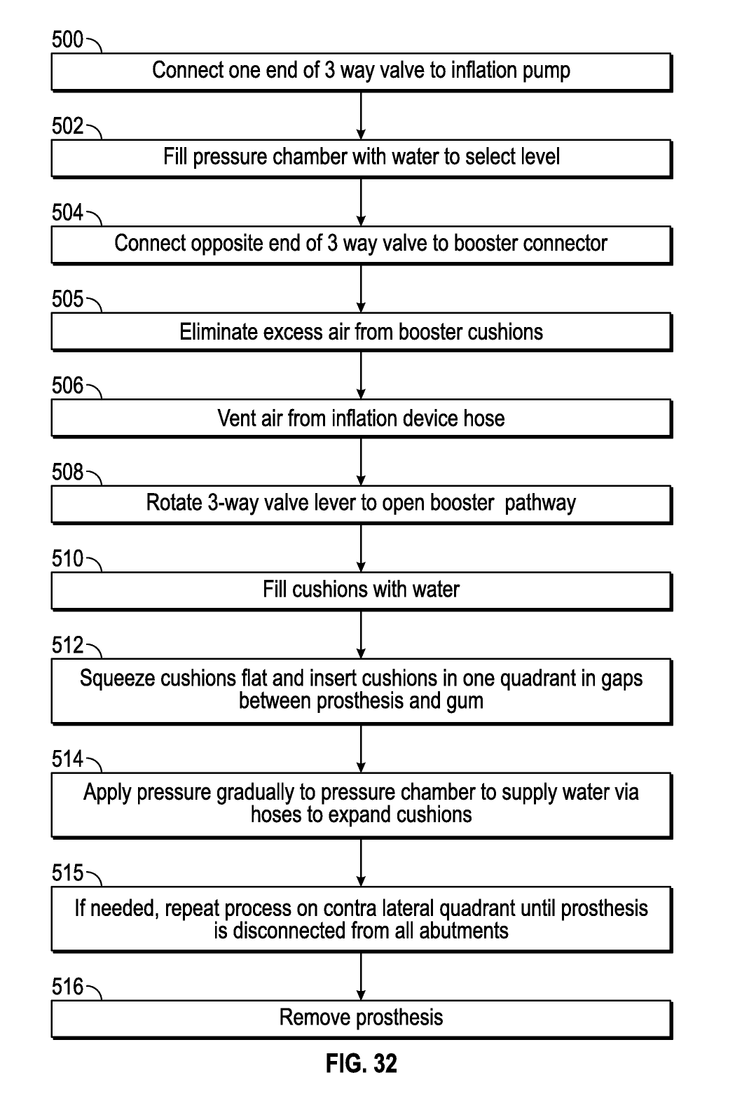

In one embodiment of a method of using the dental prosthesis removal system of FIGS. 23 to 31, the dental professional first decides how many booster tubes are needed and the appropriate sizes of booster cushions needed depending on the width of gaps between abutments secured to respective implants or tooth roots, as in the previous embodiments. The selected booster tubes are then connected to the connection manifold 401. In one embodiment, prior to connection of the hose 414 to Luer fitting 415 of the three way valve, the pressure chamber and hose 416 are filled with liquid such as sterilized water to the desired level in chamber 423 in the usual manner (see steps 500 and 501 of FIG. 32), making sure that there are no large air bubbles present in chamber 423 or hose 416. If large air bubbles are observed, liquid is evacuated and the chamber and hose are re-filled. If no large air bubbles are observed, the hose 414 is connected to the three way valve (step 504), and a vacuum is created to vent air from the booster tubes and hose 414, by pressing pump release lever 428 (FIG. 30) and pulling handle 426 back to move the plunger or piston away from the outlet end of the chamber and remove excess air from the cushions (step 505) and also vent air from hose 414 (step 506). The dental professional may also manually press the cushions flat during venting to assist the air elimination process, as seen in FIG. 29. It will be understood that the foregoing steps apply to embodiments where the fluid used to inflate the booster cushions is a liquid, and these steps are not needed in embodiments where the inflation fluid is a non-toxic gas such as air.

The vacuum is released by turning the three way flow valve off lever 419 by one quarter turn counter-clockwise from the position in FIG. 30, to close the prosthesis booster pathway and open the vent pathway (i.e. so that it points to Luer fitting or outlet 415). This pulls air through the vent pathway towards the inflation device. Air is removed from the inflation device hose 416 by holding the inflation device upright, pressing locking lever 428, and pushing down on the handle 426 to fill hose 416 with liquid. After checking for any large air bubbles, the valve off lever 419 is rotated back to the previous position pointing to the vent outlet, opening the prosthesis booster pathway. The handle 426 is then turned slowly to apply sufficient pressure to fill the cushions of booster tubes 206 with liquid (step 510). The pressure gauge may be monitored to avoid applying too much pressure. In one embodiment, a pressure of around 2 atmospheres (30 psi) is used to fill the cushions with water without pressing on locking lever 428. If any large air bubbles are observed in the cushions (i.e. if the cushions are filled with more 30% air), the air elimination process described above is repeated before re-filling the cushions with liquid.

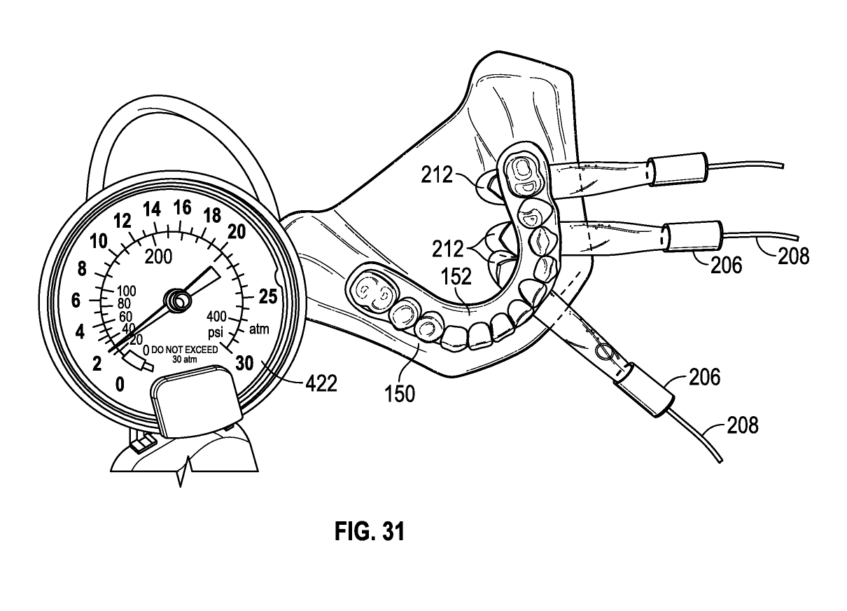

The locking lever 428 is pressed to release pressure, and the cushions are then pressed flat and inserted in selected gaps between the prosthesis and gum in the same quadrant of the patient's jaw, as seen in FIG. 31 (step 512). The cushions are inserted by working the tips between the prosthesis and soft tissue of the gum until the cushions are inserted beyond the black insertion guide line 215 and the tips protrude from the inner side of the prosthesis as in FIG. 31. All cushions are placed in the same quadrant to combine the removal forces in the most effective manner. Local anesthetic may be used prior to cushion insertion in the areas where cushions are to be placed. Pressure is then applied gradually by slowly turning handle 426 to expand the cushions and loosen or disconnect the prosthesis from the abutment (step 514). The pressure gauge is monitored to ensure a predetermined maximum pressure is not exceeded. In one embodiment, the maximum pressure was 25 atm (37 psi). If needed, the unit may be depressurized by pushing lock lever 428 and then repeating the cushion expansion steps described above until the prosthesis is completely disconnected from all abutments in the respective quadrant.

If needed, the process can be repeated by repeating the foregoing steps with the cushions placed in gaps on the contralateral side of the patient's mouth until the prosthesis is completely disconnected from any dental abutments (step 515). The prosthesis is then removed (step 516).

The booster assembly 206, hoses 406, 414, and connector 401 are then disconnected from the three way valve 405 and discarded. The remaining water is then removed from the inflation device, moving the plunger 424 back and forth several times to remove as much water from the inflation device as possible. The reusable inflation device and hose 416 may be cleaned by flushing several times with alcohol, and wiping clean with a disinfecting agent.

The detachable booster connection manifolds and booster assemblies of the embodiments of FIGS. 6 to 32 allow different booster tubes with different diameters or widths and even different numbers of booster tubes to be attached, depending on the needs of a particular case. Smaller diameter or width cushions allow for fitting between implants that are close together. Larger diameter or width cushions provide more lifting force for a given pressure. The larger the number of cushions that are inflated at the same time, the lower the pressure needed to provide the lifting force necessary to remove the prosthesis. In other words, use of two cushions requires approximately twice the pressure than if four cushions were engaged between the prosthesis and gum line.

In any of the preceding embodiments, the pressure chambers and booster tubes may be supplied pre-filled with a suitable non-toxic fluid in order to make the system easier for the clinician to use. As discussed above, any non-toxic fluid such as a liquid, a gas such as air, gels, or compressible solid may be used to fill the pressure chambers and booster tubes. The booster system of FIGS. 23 to 32 is primarily designed to be provided unfilled, which is most straightforward method of use. The booster tubes are then filled with a selected non-toxic fluid such as water, as described above. If provided unfilled, the system is less expensive and potentially autoclavable. The inflation device with pressure gauge allows the user to apply pressure gradually and view the pressure reading during inflation, reducing the risk of applying too much pressure and potentially breaking the cushions.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A dental appliance removal tool, comprising:
at least one booster tube having a distal end portion comprising pressure-actuated expandable cushion configured for placing in a space between a dental appliance and a gum line in a non-expanded state;
a fluid supply; and
an inflation device for supplying pressurized fluid from the supply to the expandable cushion, whereby the cushion is expanded to apply pressure between the gum line and dental appliance.

2. The tool of claim 1, wherein the booster tube has a non-expandable insertion tip extending from the expandable cushion up to the distal end of the booster tube.

3. The tool of claim 1, wherein the fluid supply comprises a tubular chamber of compressible material and a fluid filling the chamber, the chamber having an outlet configured for communication with the booster tube, and the inflation device comprises a pressure actuation mechanism which applies pressure to a portion of the tubular chamber to supply pressurized fluid to the booster tube and expand the cushion radially.

4. The tool of claim 3, wherein the booster tube and tubular chamber are formed integrally and fluid fills the booster tube and chamber prior to actuation of the pressure actuation mechanism.

5. The tool of claim 3, wherein the booster tube has a proximal end releasably connected to the tubular chamber.

6. The tool of claim 3, wherein the pressure actuation mechanism comprises at least one lever arm pivotally mounted relative to the tubular chamber and configured to apply pressure to the tubular chamber.

7. The tool of claim 3, wherein the pressure actuation mechanism comprises two opposing lever arms pivotally mounted on opposite sides of the tubular chamber.

8. The tool of claim 7, further comprising opposing jaws on the lever arms which squeeze opposing portions of the tubular chamber when the lever arms are urged towards one another.

9. The tool of claim 3, wherein the pressure actuation mechanism comprises a base housing containing the pressure chamber and having an opening exposing at least a portion of the pressure chamber, the base housing having a forward end portion, a pivot mount associated with the forward end portion of the base housing, a lever arm pivotally mounted on the pivot mount for pivotal movement towards and away from the base housing, and a plunger associated with the lever arm and configured to compress an opposing portion of the pressure chamber through the opening when the lever arm is pivoted towards the base housing.

10. The tool of claim 1, comprising a plurality of booster tubes each having proximal ends connected to the inflation device.

11. The tool of claim 10, wherein at least one first booster tube has a cushion having a first transverse width and at least one second booster tube has a cushion having a second transverse width different from the first transverse width, the cushions of the first and second booster tubes being configured for placement in different width spaces.

12. The tool of claim 11, further comprising a plurality of booster tubes of different transverse widths for selective connection to the inflation device.

13. The tool of claim 10, further comprising a plurality of flexible hoses of smaller diameter than the booster tube, each flexible hose connecting the proximal end of a respective booster tube to the inflation device.

14. The tool of claim 1, wherein the inflation device comprises a manually operated fluid pump having an outlet, and a fluid pathway connecting the pump outlet to the proximal end of the booster tube.

15. The tool of claim 14, comprising a plurality of booster tubes each having a proximal end configured for communication with the pump outlet via the fluid pathway.

16. The tool of claim 15, wherein one or more booster tubes have cushions of different transverse widths.

17. The tool of claim 15, wherein the fluid pathway comprises a passageway extending from the pump outlet and having an outlet end, an on-off valve in the passageway for controlling fluid supply to the booster tubes, a connection manifold having an inlet releasably connected to an outlet end of the passageway and a plurality of outlets, and a plurality of flexible hoses each having a first end connected to a respective outlet of the connection manifold and a second end configured for connection to a respective booster tube.

18. The tool of claim 1, wherein the booster tube has a transverse line providing an insertion indicator for positioning the cushion in the selected space.

19. A method of removing a dental appliance from a patient's mouth, comprising:
inserting an insertion tip on a distal end of at least one booster tube through a space between a gum line and dental appliance removably affixed over the gums until an expandable cushion of the at least one booster tube adjacent the insertion tip is positioned in the space between the gum and dental appliance; and
supplying pressurized fluid to the booster tube to radially expand the expandable cushion and apply force between the gum line and the dental appliance to release the dental appliance for removal.

20. The method of claim 19, wherein the step of supplying pressurized fluid comprises applying pressure to a compressible wall of a fluid-filled chamber in communication with a proximal end of the booster tube, whereby pressurized fluid is supplied from the chamber to the expandable cushion.

21. The method of claim 20, wherein the step of applying pressure to the compressible wall of the chamber comprises positioning the fluid-filled chamber between jaws of opposing, pivotally mounted lever arms and squeezing the arms towards one another in order to compress the chamber between the jaws.

22. The method of claim 20, wherein the step of applying pressure to the compressible wall of the chamber comprises moving a pivotally mounted lever arm towards a rigid housing in which the chamber is mounted until a plunger secured to the lever arm engages a wall portion of the chamber through an opening in the housing to compress the chamber and supply pressurized fluid to the expandable cushion of the booster tube.

23. The method of claim 19, wherein the step of inserting an insertion tip comprises inserting insertion tips on distal ends of a plurality of booster tubes through selected spaces between a gum line and dental appliance in one quadrant of a patient's mouth until expandable cushions of the respective booster tubes are positioned in the respective selected spaces between the gum and dental appliance, and supplying pressurized fluid to the booster tubes simultaneously to radially expand the cushions and apply force between the gum line and the dental appliance in each selected space.

24. The method of claim 23, wherein cushions of two or more booster tubes are positioned in the respective selected spaces.

25. The method of claim 24, wherein at least one cushion has a different transverse width from at least one other cushion.

26. The method of claim 24, wherein the step of positioning the cushions comprises inserting the insertion tip through the space until a transverse indicator line on the respective cushion is aligned with an outer edge of the dental appliance.

27. The method of claim 24, wherein the step of supplying pressurized fluid to the booster tubes comprises connecting each booster tube to a manually operated fluid pump having an outlet connected to the booster tubes via a connection manifold.

28. The method of claim 23, wherein the spaces are located between spaced attachment assemblies each having a first part secured to a respective implant or tooth root and a second part associated with the dental appliance and releasably secured to the first part.
